(19) United States
(12) Patent Application Publication
(10) Pub. No.: US 2026/0250144 A1
(43) Pub. Date: Aug. 27, 2026

(54) METHOD AND DEVICE FOR PRODUCING PARTICLES WITH A HIGH MAGNESIUM CONTENT FROM SEA WATER

(71) Applicant: Rainer Pommersheim, Mainz-Kastel (DE)

(72) Inventors: Rainer Pommersheim, Mainz-Kastel (DE); Denis Breuch, Bingen am Rhein (DE); Holger Löwe, Oppenheim (DE)

(21) Appl. No.: 18/854,241

(22) PCT Filed: Feb. 13, 2023
(86) PCT No.: PCT/EP2023/053468

§ 371 Date: Oct. 4, 2024

(30) Foreign Application Priority Data
Apr. 7, 2022 (DE) 10 2022 108 490.6
Jan. 11, 2023 (DE) 10 2023 100 537.5

(51) Int. Cl. C01F 5/22

(52) U.S. Cl. CPC C01F 5/22

(57) ABSTRACT

The invention relates to a method and a device, by means of which particles with a high magnesium content can be obtained from sea water. The particles can be magnesium hydroxide for example as well as other water-insoluble magnesium salts, such as magnesium sulfate, magnesium carbonate, etc., for example. The particles are produced in a precipitation process using a suitable alkali reagent. When the precipitation is carried out using a nozzle construction according to the invention and/or while adding auxiliary reagents, the size of the obtained particles and the yield thereof can be influenced within a specified range. The aqueous suspension obtained from the process can be further processed in order to produce different products, up to metallic magnesium for metallurgy, using existing technical methods.

### DESCRIPTION

The present invention relates to a method and a technical device for extracting particles from sea water which have a high magnesium content. Such particles can be, for example, magnesium hydroxide or other water-insoluble magnesium salts such as magnesium sulfate, magnesium carbonate, etc.

According to the invention, the particles are produced in a precipitation process using a suitable alkali reagent. If this precipitation is carried out with the aid of a nozzle assembly according to the invention and/or with the addition of auxiliary reagents, the size of the particles obtained and their yield can be influenced. The aqueous suspension obtained from the process can be further processed into various products using known technical methods, including metallic magnesium for metallurgy.

Magnesium-containing raw materials, in particular magnesium hydroxide, are very important raw materials for industry. In nature, magnesium hydroxide occurs in crystalline form as so-called brucite and is also mined industrially as ore. As brucite can only be mined on an industrial scale in a few regions of the world, but the demand for magnesium-containing raw materials and magnesium hydroxide in particular is constantly increasing, other ways of extracting it are increasingly coming into focus. These include in particular the precipitation of water-soluble magnesium salts, such as magnesium chloride with a hydroxide in aqueous solution.

The world's oceans contain large quantities of different salts. Their average salt content is around 3.5%, i.e. 35 g/litre. The composition of sea water is almost the same in all regions of the world. The proportion of magnesium chloride in sea water is around 11% of the salt content. This makes sea water a practically inexhaustible raw material source for magnesium salts.

It is therefore obvious that research has been carried out for decades in the field of magnesium extraction from sea water. The following is a representative list of some of the relevant intellectual property rights.

In the method according to DE 11 96 172 B, magnesium hydroxide is obtained from sea water by precipitation with a 5 to 10% aqueous suspension of a calcium carbide waste liquor (consisting mainly of calcium oxide, aluminium oxide, iron oxide and silicon oxide). The method involves the following steps:
1. separating calcium carbide waste liquor in a milky state into less pure and purer portions;
2. converting sea water with the less pure portion of calcium carbide waste liquor obtained to produce non-carbonated sea water;
3. converting the non-carbonated sea water with the purer portion of the calcium carbide waste liquor to produce magnesium hydroxide; and
4. separating the magnesium hydroxide obtained into a pure and a less pure fraction.

Conversion/precipitation takes place here discontinuously in clarifiers with subsequent mechanical separation (liquid cyclone) of the precipitated magnesium hydroxide. The use of calcium carbide waste liquor instead of calcium hydroxide, for example, which is much cheaper, is likely to make the process even more expensive.

GB 543 665 A describes a method for extracting magnesium salts from sea water and a method for pre-treating the sea water in order to reduce its carbon dioxide, bicarbonate and carbonate content by adding calcium hydroxide or oxide. After precipitation of the calcium carbonate, the Mg(II) solution can be further processed.

This property right basically discloses a method for pre-treating sea water so that the named salts can be obtained from it. A technical process for the actual extraction of these salts is not disclosed.

U.S. Pat. No. 3 111 376 deals with a continuous process for the preparation of magnesium hydroxide from a magnesium chloride solution with dolomite (CaMg(CO₃)₂). The precipitation of the magnesium hydroxide takes place at elevated temperatures (up to 90° C.) at which dolomite is converted in situ into the corresponding hydroxides (Ca(OH)₂).

However, due to the relatively high temperatures and the reagents used, the method is likely to be quite expensive and uneconomical for widespread technical application.

Seawater is pre-treated with sodium carbonate in accordance with GB 535 852 A to precipitate calcium salts. After separating the calcium carbonates, the sea water is then mixed with sodium hydroxide to obtain the desired magnesium hydroxide, which is then filtered off.

Due to the sodium hydroxide used as a precipitating reagent and the high pH value generated in the system as a result, precipitation of all polyvalent ions is to be expected, which leads to a highly contaminated product.

U.S. Pat. No. 2,405,055 describes a method for extracting magnesium hydroxide from sea water. Here, sea water is mixed directly with a (super-)stoichiometric amount of calcium hydroxide milk of lime and stirred in a reactor until complete conversion to magnesium hydroxide. Lastly, the precipitated magnesium hydroxide is separated off.

Due to the nature of the method, the particles obtained are relatively large. Fresh water is also used in the production of milk of lime, which leads to an increase in production costs.

WO 0029326 A1 describes a method for producing magnesium hydroxide from sea water, in which the magnesium hydroxide is precipitated with sodium hydroxide solution obtained from sea water by electrodialysis.

By using sodium hydroxide as a precipitating reagent, a number of other salts will also precipitate due to the high pH value generated, which leads to considerable contamination of the product.

WO 2016/193087 A1 describes how micro-and nanoparticles can be produced from the solutions of two salts by precipitation with the aid of a specially designed nozzle. The particle size can be influenced by changing the flow rates and by adding surface-active substances.

Solutions of salts are used almost exclusively in the process described. The use of lyes as precipitating reagents is not provided.

DE 10 2004 026 725 A1 discloses a modular nozzle system for producing droplets from liquids of different viscosities. The arrangement described there relates to a gas-liquid nozzle in which the liquid is pumped through internal capillaries and the gas flowing around the liquid serves to ensure droplet break-off.

From the foregoing, the invention therefore addresses the problem of providing a further developed method in the sense of a practically applicable technical process and a device for obtaining particles from sea water, wherein the particles have a high magnesium content.

The problem addressed by the invention is solved using the teachings or features and feature groups of the independent claims, wherein the dependent claims comprise at least expedient embodiments and developments.

Proceeding from the known prior art, the present invention relates to a method and a device with the aid of which small particles with a high magnesium content can be produced from sea water.

The basic idea of the invention is to convert the readily water-soluble magnesium chloride contained in sea water into an almost water-insoluble form, for example magnesium hydroxide, and thus to precipitate it.

The magnesium chloride, for example, is converted into the almost water-insoluble magnesium hydroxide by simply raising the pH value in the system above a value of 12. If the pH value is raised further, to 14, for example, magnesium hydroxide is still formed. However, at this high pH value, almost all other salts contained in the sea water are converted into water-insoluble hydroxides, which leads to undesirable contamination of the desired magnesium hydroxide.

A simple and inexpensive solution to limit the pH to 12 is to use calcium hydroxide, which is not easily soluble in water, instead of sodium hydroxide, for example. Calcium hydroxide is only soluble in water up to approximately 1.7 g/litre at room temperature, which limits the pH value of the solution to 12.

Another way to adjust the pH value is to apply a voltage to increase the pH value.

It is therefore possible to adjust the pH value of the sea water to the required value of 12 not only by adding Ca(OH)₂, but also by applying an electrical voltage in the sense of electrolysis.

If the voltage is increased above a limit value to be determined experimentally, a large proportion of the dissolved salts will precipitate. In this way, it would be possible to provide a salt mixture or a highly salt-reduced sea water that can be further processed or used in a manner known per se.

The method according to the invention differs from the prior art in that a saturated Ca(OH)₂ solution can be produced directly from sea water by using an excess of Ca(OH)₂ in the first method step. The use of fresh water is not necessary. The nozzle, which is explained in greater detail below, enables the provision of very small particles, the size of which can also be influenced by the flow parameters of the reaction liquids. A combination with the use of the nozzle according to the invention, which serves to produce the particles directly from sea water, is neither known nor obvious from the prior art.

If a saturated calcium hydroxide solution is mixed with sea water, magnesium hydroxide immediately precipitates. However, the particles are quite large and their size distribution is very broad.

In order to produce small particles with a narrow size distribution from magnesium chloride, a special nozzle is used in the present invention. With the aid of this nozzle, the sea water is brought into contact with the saturated calcium hydroxide solution in a controlled manner within defined parameters and not in an uncontrolled manner, such as by simple stirring, for example.

The invention will be explained in greater detail below with reference to exemplary embodiments and with the aid of figures.

The Figures show:

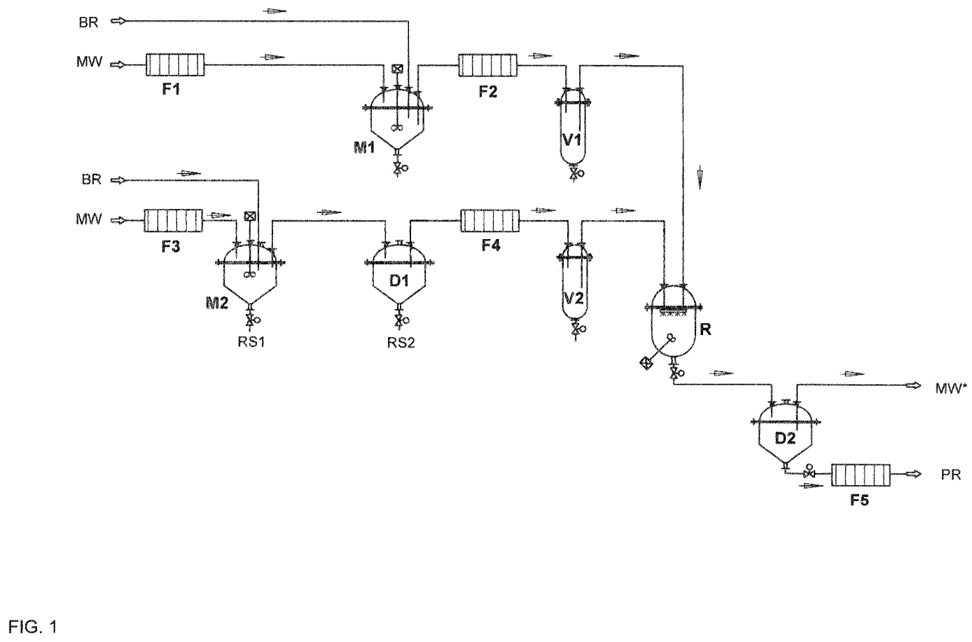

FIG. 1 an exemplary explanation of a system for carrying out a technical process for obtaining magnesium particles from sea water;

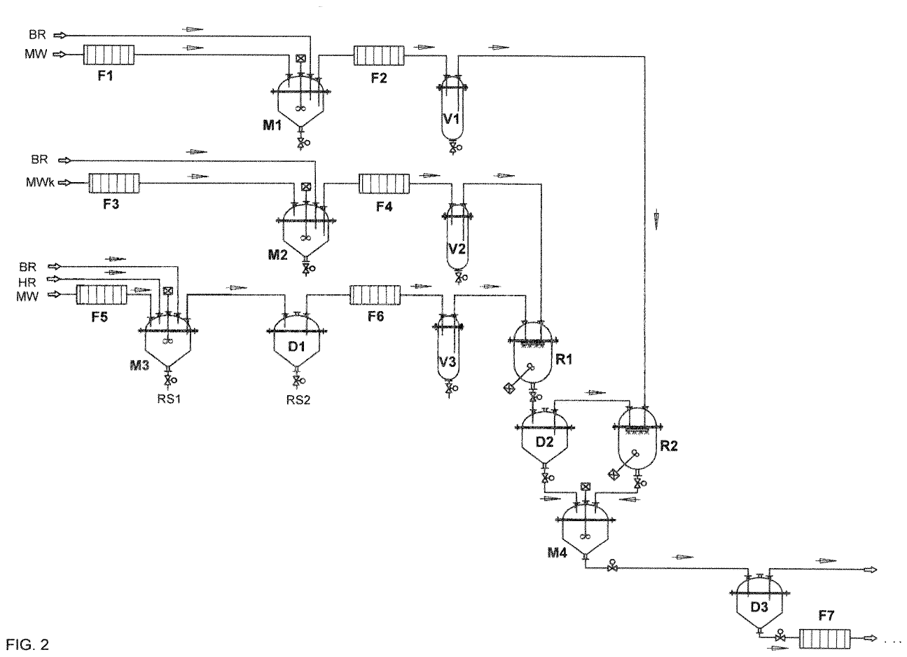

FIG. 2 a schematic representation of a technical process for exemplary implementation of the method according to the third example, and

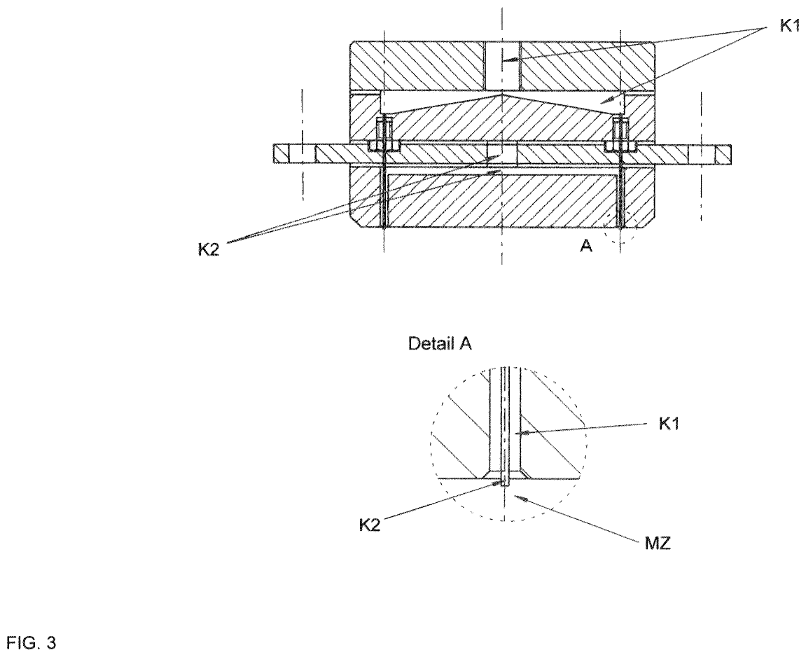

FIG. 3 a sectional view and a detailed view of the nozzle or multiple nozzle according to the invention, in which capillaries are located in the centre of several vertical, cylindrical channels.

According to the invention, a multiple nozzle is used, which is designed as follows (FIG. 3): Capillaries are located in the centre of several vertical, cylindrical channels. The inner diameter of the capillaries and the free cross-section of the cylindrical channels have a diameter of a few millimetres. One of the reaction liquids (K1 and K2) flows through each of the capillaries and the cylindrical channels. The dimensions of the resulting cross-sections through which the liquids flow are comparable and selected so that the flow rate per channel is in the range of a few litres per minute even with laminar flows. The individual cylindrical channels and the capillaries inside them are connected within the nozzle by horizontal channels in such a way that the flow conditions in each channel and in each capillary are almost identical.

The nozzle is designed in such a way that the two liquid flows only come into contact in the outer outlet region, i.e. outside the nozzle (MZ). This prevents clogging of the nozzle and increases the reliability of the method.

If the inlet pressure of both liquids K1 and K2 flowing through such a nozzle is now changed, the flow parameters through the capillaries and through the vertical, cylindrical channels also change.

Experiments have shown that with laminar flows through the nozzle, i.e. with values of the Reynolds number below 10,000, the diameter of the particles obtained is determined by the flow velocity.

For example, with the same nozzle at low flow rates, particle diameters in the um range are obtained, while at higher flow rates, which are close to the limit of turbulent flow, particles with a significantly smaller diameter are produced. In the turbulent flow range, the particle diameter then always remains almost constant.

By adding a surface-active liquid, such as a detergent, the diameter of the particles obtained can be further reduced. The higher the concentration of detergent in both solutions supplied to the nozzle, the smaller the particles become. Similar effects can be observed by changing the concentration and/or temperature of the reaction solutions.

In order to achieve a sufficient volume throughput for industrial applications, several of the multi-capillary nozzles described here can be combined in nozzle heads. In these nozzle heads, both the capillaries for the liquid transport and the channels for the gas flowing concentrically around them are incorporated in superimposed plates or planes.

### EXAMPLE 1

A saturated calcium hydroxide solution is prepared by stirring in, for example, 4 g of calcium hydroxide to one litre of fresh water, then filtered off and poured into a storage container. Sea water, which has also been previously filtered, is poured into a second container. These two clear solutions are then fed into a nozzle, which is constructed as described above and in which one solution flows through the capillary and the other through the surrounding cylindrical channel. At the outlet of the nozzle, magnesium hydroxide is obtained as an aqueous suspension. By changing the inlet pressure on the nozzle, different flow conditions are created inside the nozzle. This leads to different particle sizes in the resulting suspension. The powdered magnesium hydroxide can be obtained from the suspension by simple sedimentation or by filtration.

### EXAMPLE 2

A saturated calcium hydroxide solution is prepared by stirring in, for example, 4 g of calcium hydroxide to one litre of sea water, then filtered off and poured into a storage vessel. Using the sea water means that a number of the salts contained in the water, including the magnesium chloride it contains, are precipitated. The suspension is therefore decanted before filtration. Sea water, which has also been previously filtered, is poured into a second vessel. These two clear solutions are then fed to a nozzle, which is constructed as described above and in which one solution flows through the capillary and the other through the surrounding cylindrical channel. At the outlet of the nozzle, magnesium hydroxide is obtained as an aqueous suspension. By changing the inlet pressure on the nozzle, different flow conditions are created inside the nozzle. This leads to different particle sizes in the resulting suspension. The powdered magnesium hydroxide can be obtained from the suspension by simple sedimentation or by filtration.

### EXAMPLE 3

If it is desired to work at a pH of 14 and not 12 as in the examples above, the following approach should be adopted: A saturated sodium hydroxide solution is prepared by stirring in, for Example, 4 g of calcium hydroxide and 6 g of sodium carbonate to one litre of water, then filtered off and poured into a storage vessel. If sea water is used instead of fresh water, the suspension must be sedimented as in Example 2 before further use and the supernatant filtered, otherwise simple filtration is sufficient. Seawater, which has also been previously filtered, is poured into a second container. These two clear solutions are then fed into a nozzle, which is constructed as described above and in which one solution flows through the capillary and the other through the surrounding cylindrical channel. An aqueous suspension is obtained at the outlet of the nozzle. By changing the inlet pressure on the nozzle, different flow conditions are created inside the nozzle.

This leads to different particle sizes in the resulting suspension. Only approximately 80% of the solids content of the suspension is magnesium hydroxide. It can be separated from the suspension by simple sedimentation or filtration.

### EXAMPLE 4

If the method described in Example 2 is implemented in a technical process, this can be structured as shown in FIG. 1:

To prepare the basic solution with a pH of 12, the basic reagent (e.g. calcium hydroxide) is transferred to the mixing tank M2 and stirred into sea water (MW), which has previously been filtered through the filter F3 to form a clear liquid. The aqueous supernatant in M2 is fed to the settling vessel (decanter) D1. The aqueous supernatant from D1 is transferred to the storage tank V2 via the filter F4, from where it is pumped into the reaction tank R as a clear solution. The second liquid stream that is pumped into R is sea water. To increase the yield, a small amount (below the solubility limit) of a basic reagent, for example calcium hydroxide, is added to this liquid so that its pH is raised to approximately 10 (see the upper part of the flow diagram in FIG. 1). For this purpose, sea water MW is filtered through the filter F1 and pumped into the mixing tank M1. The basic reagent BR, for example calcium hydroxide, is stirred into this water in M1 at a concentration of up to approximately 1 g/litre. The solution obtained in this way is transferred via the filter F2 into the storage container V1 and from there into the reaction vessel R. Inside the reaction vessel R there is a nozzle head as described above, through which the two liquids are pumped into the vessel and at the outlet of which the desired particles (e.g. magnesium hydroxide) are produced. If no defined, small particles are required, the two liquids can also be fed past the nozzle head into R and mixed with the agitator from R. The suspension from R is channelled into the settling vessel D2, where it is concentrated. The aqueous supernatant MW* is disposed of, while the product (e.g. magnesium hydroxide) is separated from the sink fraction using the filter F5. The magnesium hydroxide obtained in this way can then be dried and fed to other industrial processes, such as the electrolytic recovery of metallic magnesium.

### EXAMPLE 5

If the method described in Example 3 is implemented in a technical process, this can be structured as shown in FIG. 2. This corresponds in large part to that of Example 4, and the information given there also applies here accordingly.

In contrast, the suspension obtained in R (here R1) is mixed a second time with sea water to convert the hydroxide contained in its aqueous supernatant to magnesium hydroxide. This is pumped into R2 and reacted there with the sea water prepared via F1, M1, F2 and V1. The suspensions from D2 and R2 are then combined in M4 and concentrated in the sink tank D3. The aqueous supernatant MW* is disposed of, while the product (e.g. magnesium hydroxide) is separated off from the sink fraction using the filter F5. The magnesium hydroxide obtained in this way can then be dried and fed to other industrial processes, such as the electrolytic recovery of metallic magnesium.

1. A method for producing particles with a high magnesium content from sea water, wherein the readily water-soluble magnesium chloride contained in the sea water is converted into a water-insoluble form and precipitated, further wherein this conversion is effected by raising the pH value in the system to a range equal to or above pH 12 and the precipitated particles are fed to a nozzle arrangement in order to achieve an adjustment of the particle size and a homogenisation of the size distribution of the particles obtained.

2. The method according to claim 1,
characterised in that
the magnesium chloride is converted into water-insoluble magnesium hydroxide by limiting the pH value to 12 and for this purpose the sea water is introduced, in particular stirred, into a saturated calcium hydroxide solution.

3. The method according to claim 1,
characterised in that
the pH value of the sea water is adjusted to a value in the region pH-12 by applying an electrical voltage.

4. A device for obtaining particles from sea water with a high magnesium content, based on a precipitation process with a suitable alkali reagent, in particular by a method according to claim 1,
characterised in that,
in order to provide small particles with a narrow size distribution, a nozzle arrangement is provided in order to bring sea water into contact with saturated calcium hydroxide solution in a controlled manner, wherein the nozzle has capillaries in the centre of a plurality of vertical cylindrical channels, the internal diameter of which and the free cross-section of the cylindrical channels are in the region of a few millimetres, one of the reaction liquids can be fed to each of the capillaries and the cylindrical channels, wherein the cylindrical channels and the capillaries within the nozzle are connected to one another by channels in such a way that the flow conditions in each channel and in each of the capillaries are virtually identical and the particle size can be predetermined by adjusting the flow parameters of the reaction liquids.

5. The device according to claim 4,
characterised in that
the liquid flows of the reaction liquids combine or come into contact outside the nozzle in the opening region of the respective cylindrical channel with internal capillary and form a mixing zone (MZ).
